(19) United States
(12) Patent Application Publication
(10) Pub. No.: US 2016/0052072 A1
(43) Pub. Date: Feb. 25, 2016

(54) ASYMMETRIC END MILLS AND APPLICATIONS THEREOF

(71) Applicant: Kennametal lnc., Latrope, PA (US)

(72) Inventors: Danny Ray DAVIS, Asheboro, NC (US); Stephen G. PRITCHARD, Bennett, NC (US)

(21) Appl. No.: 14/466,390

(22) Filed: Aug. 22, 2014

(51) Int. Cl. B23C 5/10; B23P 15/34

(52) U.S. Cl. CPC B23C 5/10; B23P 15/34; B23C 2210/03; B23C 2210/0492; B23C 2210/202; B23C 2210/203; B23C 2210/282; B23C 2210/40; B23C 2240/08

(57) ABSTRACT

In one aspect, rotationally balanced asymmetric end mills are described herein. An end mill described herein comprises a shank portion extending along a longitudinal axis of the end mill, and a cutting portion extending from the shank portion. The cutting portion comprises a plurality of unequally indexed blades separated by flutes along an axial length of cut, the blades extending onto a cutting end surface of the end mill, wherein at least one of the flutes is of unequal length and the asymmetric end mill has an imbalance of 2.0 gmm or less.

### FIELD

The present invention relates to end mills and, in particular, to end mills employing an asymmetric architecture.

### BACKGROUND

End mills of various designs and construction are well known and advantageously employed in a number of cutting applications. Over time, cutting speeds achieved by end mills have increased to provide greater efficiencies in cutting and machining operations. In order to accommodate increased cutting speeds, new geometries and materials have been introduced.

To reduce irregularities and maintain high quality surface finish, end mills for use in high speed cutting applications are conventionally fabricated using symmetrical designs and with a limited number of flutes and/or cutting edges. Limiting the cutting edge number of a symmetrical end mill can preclude mismatch between the rate of cutting edge impacts and the characteristic set of resonant frequencies at which the cutting system (e.g. spindle and end mill) inherently desires to vibrate. However, a limited number of cutting edges and associated flutes can reduce maximum cutting speeds and frustrate efficient material ejection during the cutting operation.

End mill design continues to evolve in response to the changing demands of cutting applications, thereby calling for the development of new end mill architectures and configurations.

### SUMMARY

In one aspect, end mills are described herein employing an asymmetric architecture for material removal in high speed cutting and/or milling applications. For example, an asymmetric end mill described herein comprises a shank portion extending along a longitudinal axis of the end mill and a cutting portion extending from the shank portion. The cutting portion comprises a plurality of unequally indexed blades separated by flutes along an axial length of cut, the blades extending onto a cutting end surface of the end mill, wherein at least one of the flutes is of unequal length and the asymmetric end mill has an imbalance of 2.0 gram-millimeters (“gmm”) or less. The blades can be disposed at one or more helical angles from the longitudinal axis along the axial length of cut. Further, an asymmetric end mill described herein, in some embodiments, has at least three flutes or at least four flutes.

In another aspect, methods of machining an object are described herein. A method of machining comprises contacting the object with an asymmetric end mill rotating about a longitudinal axis at a predetermined rate, the end mill comprising a shank portion and a cutting portion extending from the shank portion. The cutting portion of the end mill comprises a plurality of unequally indexed blades separated by flutes along an axial length of cut, the blades extending onto a cutting end surface of the end mill, wherein at least one of the flutes is of unequal length and the asymmetric end mill has an imbalance of 2.0 gmm or less. In some cases, the predetermined rate is at least 18,000 revolutions per minute (RPM) or at least 25,000 RPM.

In a further aspect, methods of making an asymmetric end mill are described herein. A method of making an asymmetric end mill comprises forming a cutting portion of the end mill by providing a blank and mechanically working the blank to provide a plurality of unequally indexed blades separated by flutes along an axial length of cut. The cutting portion is balanced by adjusting the length of one or more flutes wherein at least one of the flutes is of unequal length. The blank is further mechanically worked to provide a cutting end surface, the unequally indexed blades extending onto the cutting end surface. The cutting portion is then rebalanced by adjusting one or more gash angles. In some embodiments, the cutting portion has an imbalance of less than about 2.0 gmm after adjusting the length of one or more of the flutes. Moreover, the cutting portion can have an imbalance of less than about 2.0 gmm after adjusting one or more of the gash angles. In some embodiments, the rebalanced cutting portion is subsequently coupled to a shank portion to further complete construction of the asymmetrical end mill. In other embodiments, the blank portion has a shank portion continuous with the cutting portion.

### BRIEF DESCRIPTION OF THE DRAWINGS

FIGS. 1A-1C illustrate multiple elevation views of an asymmetric solid end mill according to one embodiment described herein.

FIG. 2 illustrates a perspective view of an asymmetric solid end mill according to one embodiment described herein.

FIG. 3 illustrates a schematic end view of an asymmetric solid end mill according to one embodiment described herein.

### DETAILED DESCRIPTION

Embodiments described herein can be understood more readily by reference to the following detailed description and examples and their previous and following descriptions. Elements and apparatus described herein, however, are not limited to the specific embodiments presented in the detailed description. It should be recognized that these embodiments are merely illustrative of the principles of the present invention. Numerous modifications and adaptations will be readily apparent to those of skill in the art without departing from the spirit and scope of the invention.

### I. Asymmetric End Mills

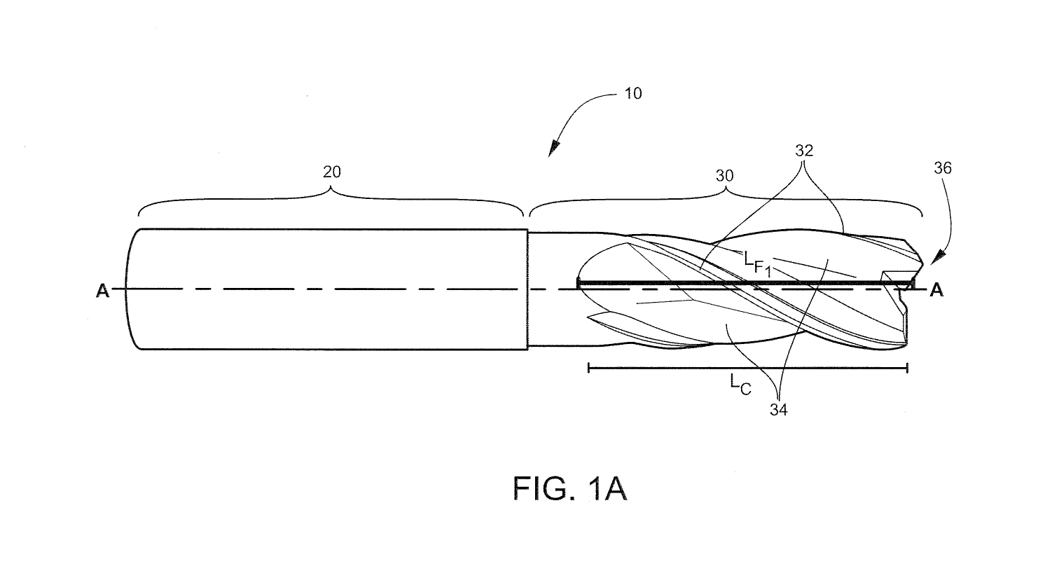

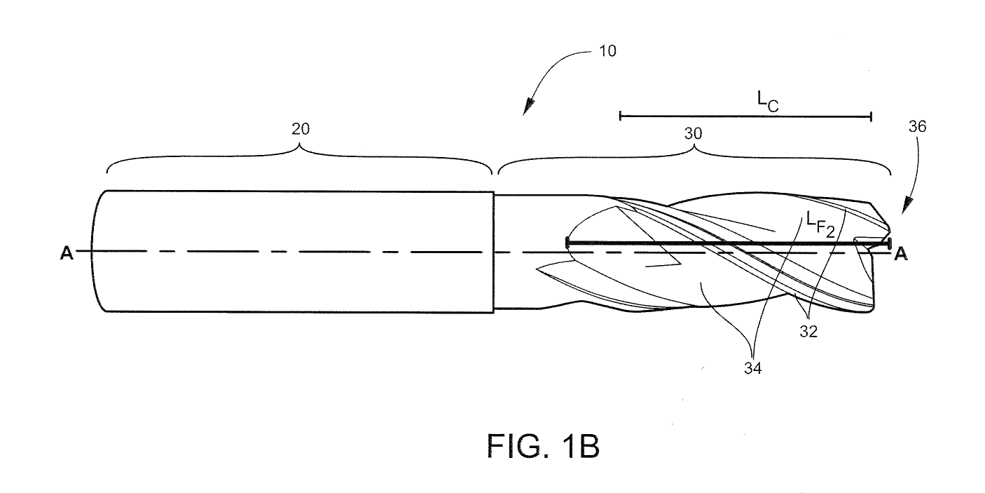

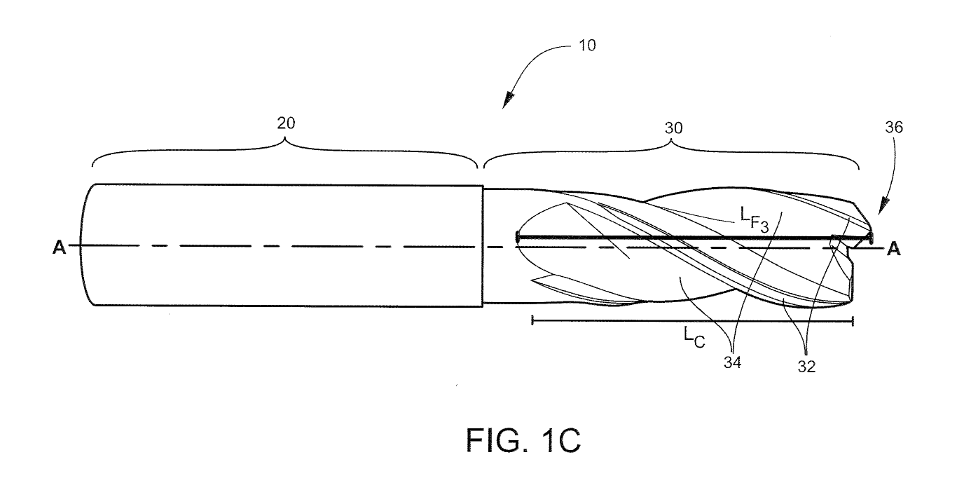

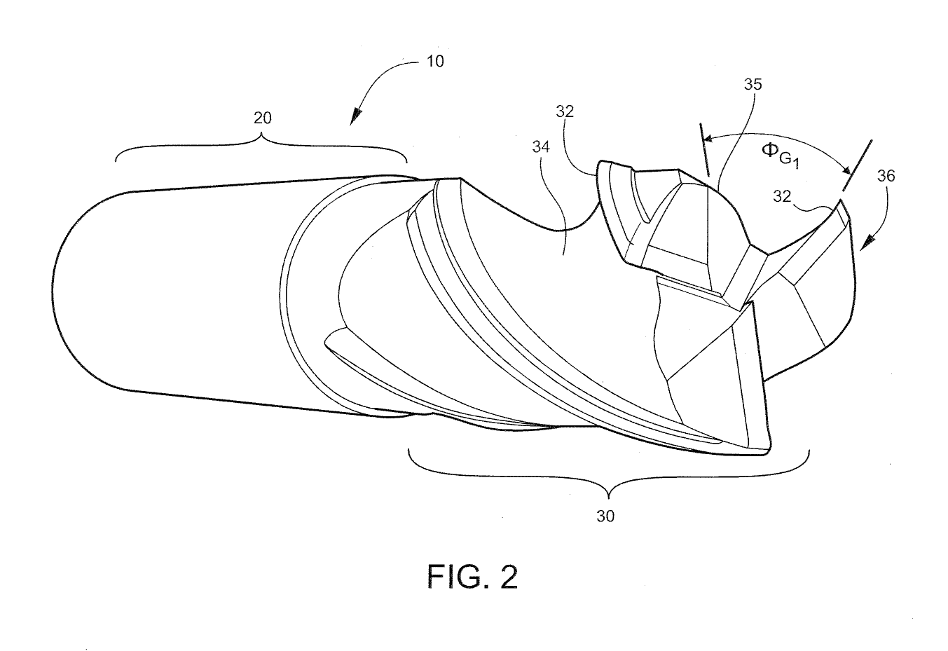

Referring now to FIGS. 1 and 2, there is illustrated an asymmetric end mill, generally designated as reference number 10, in accordance with one embodiment described herein. As provided in FIGS. 1 and 2, the end mill (10) comprises a shank portion (20) extending along a longitudinal axis (A-A) of the end mill (10) and a cutting portion (30) extending from the shank portion (20). The cutting portion (30) comprises a plurality of unequally indexed blades (32) separated by flutes (34) along an axial length of cut (L_{C}), the blades (32) extending onto a cutting end surface (36) of the end mill (10). At least one of the flutes (34) is of unequal length relative to the remaining flutes. The end mill (10) has an imbalance of 2.0 gmm or less.

The cutting portion (30) can have any number of blades (32) and flutes (34) in any shape or configuration not inconsistent with the objectives of the present invention. For example, the cutting portion (30) can have at least three flutes (34) as illustrated in FIGS. 1 and 2 or at least four flutes (34). The blades (32) are disposed at one or more helical angles from the longitudinal axis (A-A) along the axial length of cut (L_{C}). In such embodiments, the helical angle of one or more blades (32) can vary along the axial length of cut (L_{C}). Alternatively, the helical angle of one or more blades (32) remains constant along the axial length of cut (L_{C}).

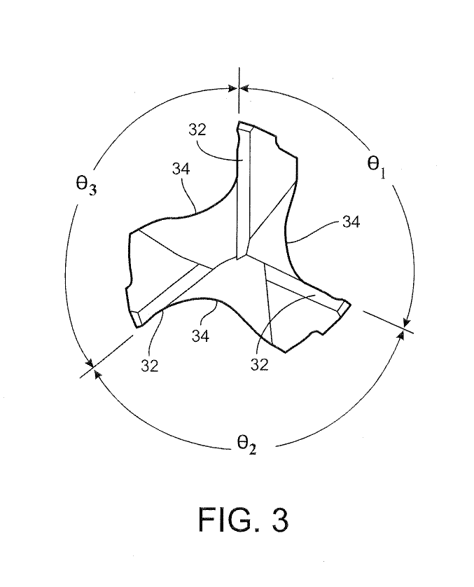

FIG. 3 illustrates unequal blade indexing created by uneven flute spacing. As illustrated in FIG. 3, index angles (θ₁, θ₂, θ₃) of unequal value are established between the blades (32). Index angles can be individually or collectively adjusted to disrupt harmonic frequencies that can lead to chatter during cutting operations. In some embodiments, two or more index angles can be of equal value. For example, opposite index angles in a four flute configuration can be equal while adjacent index angles are unequal.

As described herein, at least one of the flutes (34) is of unequal length. A determination of whether a flute (34) is of an unequal length can be made by comparison of any two individual flutes (34) of the asymmetric end mill (10). When such a comparison is undertaken, the presence of any two flutes (34) having unequal lengths (L_{F}) relative to one another signifies that at least one of the flutes (34) is of unequal length. In some embodiments, all but one of the flutes (34) are of equal length, with an individual flute (34) being of a different length. In certain other cases, two or more flutes (34) may have unequal length (L_{F}). In further embodiments, all flutes (34) are of unequal length relative to one another. FIGS. 1A-1C illustrate an embodiment where all flute lengths (L_{F1} L_{F2} and L_{F3}) are unequal. As discussed further herein, length of individual flutes (34) can be varied in order to reduce imbalance resulting from the asymmetrical design of the end mill (10).

Asymmetric end mills (10) can further comprise additional components, elements, structures or configurations not inconsistent with the objectives of the present invention. For example, as illustrated in FIG. 2, a trailing edge of a blade (32) formed by a flute (34) can exhibit a gash (35) which forms a gash angle, Φ_{G1}, with an adjacent leading edge of a blade (32). Gash angle(s) can have any value not inconsistent with the objectives of the present invention. As discussed further herein, one or more gash angles can be varied to reduce imbalance resulting from the asymmetrical design of the end mill (10)

Asymmetric end mills described herein have an imbalance of 2.0 gmm or less. For the purposes of the present disclosure, the term “imbalance” refers to static imbalance or unbalance. “Static imbalance” indicates that a mass center of an end mill does not lie on the axis of rotation or longitudinal axis (A-A) and is measured in the amount of mass or weight at a particular length radially away from the longitudinal axis (A-A) necessary for application to balance the end mill. Static imbalance may be generally determined by placing a correction mass of a certain size in a position where it counteracts the imbalance in a rotor or end mill and measuring the resulting phase and magnitude of bearing vibration during rotation of the end mill. In some embodiments, end mills described herein have an imbalance of 1.0 gmm or less. In some embodiments, end mills described herein have an imbalance of 1.0 to 2.0 gmm or 0.5 to 1.0 gmm. Importantly, balance of the asymmetrical end mill can be provided by the functional cutting geometry of the end mill. For example, unequal flute length discussed herein can assist in reducing imbalance resulting from the asymmetrical geometry of the end mill. Additionally, variance in the gash angle(s) can be used in conjunction with unequal flute length to balance the asymmetric end mill within desirable tolerances. Therefore, in some embodiments, non-functional notches, grinds or other structures are not required for balancing the asymmetrical end mill.

End mills described herein can comprise or be formed of any material not inconsistent with the objectives of the present invention. For example, end mills can be formed of ceramic, cermet, carbides (such as cemented carbides), high speed steel, cubic boron nitride, polycrystalline diamond or combinations thereof Further, end mills described herein can be constructed or formed of any number of components or subcomponents not inconsistent with the objectives of the present invention. For example, the cutting portion (30) of the end mill (10) in the embodiment of FIG. 1 can be a monolithic configuration or structure. Alternatively, the cutting portion (30) can comprise or be formed from multiple sections affixed or coupled to one another by one or more of permanent or nonpermanent mechanical or chemical joining, such as by brazing. Further, the cutting portion (30) can be monolithically or integrally formed or constructed with the shank portion (20). In other cases, the cutting portion (30) is affixed or coupled to the shank portion by one or more of permanent or nonpermanent mechanical or chemical joining, such as by brazing the cutting portion to the shank portion (20). In some embodiments, the shank portion (20) and the cutting portion (30) are formed of substantially the same material. In certain other embodiments, the shank portion (20) and the cutting portion (30) are formed of different materials.

### II. Methods of Machining an Object

In another aspect, methods of machining an object are described herein. Methods of machining an object comprise contacting the object with an asymmetric end mill rotating about a longitudinal axis at a predetermined rate, the end mill comprising a shank portion and a cutting portion extending from the shank portion. The cutting portion comprises a plurality of unequally indexed blades separated by flutes along an axial length of cut, the blades extending onto a cutting surface of the end mill, wherein at least one of the flutes is of unequal length and the asymmetric end mill has an imbalance of 2.0 gmm or less. The end mill can be rotating at any predetermined rate not inconsistent with the objectives of the present invention. In some cases, the predetermined rate is designed for high speed cutting operations. In such embodiments, the predetermined rate can be at least 18,000 RPM, at least 25,000 RPM or at least 30,000 RPM. Additionally, end mills for use in methods of machining an object can have any architecture, design and/or properties recited in Section I herein.

### III. Methods of Making an Asymmetric End Mill

In a further aspect, methods of making an asymmetric end mill are described herein. A method of making an asymmetric end mill comprises forming a cutting portion of the end mill by providing a blank and mechanically working the blank to provide a plurality of unequally indexed blades separated by flutes along an axial length of cut. The cutting portion is balanced by adjusting the length of one or more flutes wherein at least one of the flutes is of unequal length. The blank is further mechanically worked to provide a cutting end surface, the unequally indexed blades extending onto the cutting end surface. The cutting portion is then rebalanced by adjusting one or more gash angles. In some embodiments, the cutting portion has an imbalance of less than about 2.0 gmm or less than about 1.0 gmm after adjusting the length of one or more of the flutes. Moreover, the cutting portion can have an imbalance of less than about 2.0 gmm or less than about 1.0 gmm after adjusting one or more of the gash angles.

Balancing and rebalancing the cutting portion of the end mill, in some embodiments, is administered in the absence of or without reference to the shank portion of the end mill. In some embodiments, for example, the rebalanced cutting portion is subsequently coupled to a shank portion to further complete construction of the asymmetrical end mill. In other embodiments, the blank portion has a shank portion continuous with the cutting portion.

In some embodiments, computer modeling techniques are employed in methods described herein to assist in cutting geometry design of the asymmetrical end mill, including flute length and gash angle parameters to achieve balance within desired tolerances. When employing computer modeling, flute length and gash angle adjustments can be simulated to achieve the final cutting geometry, providing the asymmetrical end mill the desired balance. For example, the cutting portion can be balanced by simulating one or more adjustments to flute length. The cutting portion is then rebalanced by simulating one or more alterations to the gash angle(s). Such simulations, in some embodiments, exclude the shank portion of the end mill. In other embodiments, the simulations can include the shank portion. When finalized by simulation, the cutting geometry can be imparted to a blank by mechanical working.

Methods of making an asymmetric end mill described herein can be utilized to form any end mill consistent with the foregoing description in Section I of the present disclosure. Further, adjustments to individual components, elements, or portions of an asymmetric end mill described herein can be undertaken to achieve one or more desired results, parameters, or configurations consistent with the foregoing description in Section I of the present disclosure.

The blank utilized in methods of making an asymmetric end mill described herein can have any configuration or be made of any material consistent with the foregoing description of asymmetric end mills in Section I of the present disclosure. For example, in some cases, the blank includes a shank portion. In certain other cases, the blank does not have a shank portion and the rebalanced cutting portion is coupled to the shank portion by one or more of permanent or nonpermanent mechanical or chemical joining, such as brazing. The shank portion and the cutting portion can be formed of substantially the same material. Alternatively, the shank portion and the cutting portion are formed of different materials.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the invention.

1. An asymmetric end mill comprising:
a shank portion extending along a longitudinal axis of the end mill; and
a cutting portion extending from the shank portion, the cutting portion comprising a plurality of unequally indexed blades separated by flutes along an axial length of cut, the blades extending onto a cutting end surface of the end mill, wherein at least one of the flutes is of unequal length and the asymmetric end mill has an imbalance of 2.0 gmm or less.

2. The asymmetric end mill of claim 1, wherein the blades are disposed at one or more helical angles from the longitudinal axis along the axial length of cut.

3. The asymmetric end mill of claim 2, wherein the helical angle of one blade changes along the axial length of cut.

4. The asymmetric end mill of claim 1 having at least three flutes.

5. The asymmetric end mill of claim 1 having at least four flutes.

6. The asymmetric end mill of claim 1 having an imbalance of 1.0 gmm or less.

7. The asymmetric end mill of claim 1, wherein the cutting portion is of monolithic construction.

8. The asymmetric end mill of claim 7, wherein the cutting portion is brazed to the shank portion.

9. The asymmetric end mill of claim 1, wherein the end mill is a solid end mill.

10. The asymmetric end mill of claim 1, wherein shank portion and the cutting portion are formed of substantially the same material.

11. The asymmetric end mill of claim 1, wherein the shank portion and the cutting portion are formed of different materials.

12. A method of machining an object comprising:
contacting the object with an asymmetric end mill rotating about a longitudinal axis at a predetermined rate, the end mill comprising a shank portion and a cutting portion extending from the shank portion, the cutting portion comprising a plurality of unequally indexed blades separated by flutes along an axial length of cut, the blades extending onto a cutting end surface of the end mill, wherein at least one of the flutes is of unequal length and the asymmetric end mill has an imbalance of 2.0 gmm or less.

13. The method of claim 12, wherein the predetermined rate is at least 18,000 RPM.

14. The method of claim 12, wherein the predetermined rate is at least 25,000 RPM.

15. The method of claim 12, wherein the blades are disposed at one or more helical angles from the longitudinal axis along the axial length of cut.

16. The method of claim 15, wherein the helical angle of one blade changes along the axial length of cut.

17. The method of claim 12, wherein the asymmetric end mill has at least three flutes.

18. The method of claim 12, wherein the asymmetric end mill has at least 4 flutes.

19. The method of claim 12, wherein the asymmetric end mill has an imbalance of 1.0 gmm or less.

20. A method of making an asymmetric end mill comprising:
forming a cutting portion of the end mill by providing a blank and mechanically working the blank to provide a plurality of unequally indexed blades separated by flutes along an axial length of cut;
balancing the cutting portion by adjusting the length of one or more of the flutes wherein at least one of the flutes is of unequal length;
further mechanically working the blank to provide a cutting end surface, the unequally indexed blades extending onto the cutting end surface; and
rebalancing the cutting portion by adjusting one or more gash angles.

21. The method of claim 20, wherein cutting portion has an imbalance less than 2.0 gmm after adjusting the length of one or more of the flutes.

22. The method of claim 20, wherein the cutting portion has an imbalance of less than 2.0 gmm after adjusting one or more of the gash angles.

23. The method of claim 20 further comprising coupling the rebalanced cutting portion to a shank portion of the asymmetric end mill.

24. The method of claim 20, wherein the blank has a shank portion.

25. The method of claim 24, wherein the shank portion and the cutting portion are formed of substantially the same material.

26. The method of claim 24, wherein the shank portion and cutting portion are formed of different materials.
